(19) United States
(12) Patent Application Publication
(10) Pub. No.: US 2013/0259618 A1
(43) Pub. Date: Oct. 3, 2013

(54) GAS TANK-HANDLING DEVICE

(71) Applicants: Barry McGrane, Clogherhead (IE); Kevin Turnball, Knockbridge (IE)

(72) Inventors: Barry McGrane, Clogherhead (IE); Kevin Turnball, Knockbridge (IE)

(21) Appl. No.: 13/431,786

(22) Filed: Mar. 27, 2012

(51) Int. Cl. B66F 9/14

(52) U.S. Cl. 414/671; 414/814

(57) ABSTRACT

This invention relates to a gas tank-handling device, a method of handling a gas tank and a forklift truck having such a gas tank-handling device. Heretofore, forklift trucks have been deemed unsuitable for handling gas tanks due to high risk of damage to the gas tank or the forklift truck. Accordingly, placement of gas tanks typically requires the use of a truck loader crane to position the gas tank. This limits where the tank could be positioned on site. The present invention provides a device that enables a forklift to be used to move the gas tank. The device comprises a pair of tines mounted on and moveable laterally relative to a mounting frame and stubs mounted on the side face of the tines for engagement of the legs of the gas tank. The device will allow the gas tank to be held securely in place on the forks.

### BACKGROUND OF THE INVENTION

This invention relates to a gas tank handling device. More specifically, this invention relates to a gas tank-handling device for mounting on the lifting assembly of a forklift truck.

Gas tanks are commonly used in both domestic and commercial premises. The gas tanks typically contain liquefied petroleum gas (LPG), otherwise referred to as liquid propane gas, or other suitable gas that is used for example by the central heating system and/or cooking appliance of the premises. The gas tanks come in a range of different sizes including 250, 500 and 1000 Gallon tanks. In order to install a gas tank on site, a truck loader crane is used to lift the gas tank into position. Unfortunately, the use of a truck loader crane restricts where the gas tank may be positioned on site.

It would be highly advantageous if a forklift truck, and more specifically a piggyback forklift truck which is a particular type of lightweight forklift truck that is transported from premises to premises on the rear of a carrying vehicle, could be used to install the gas tank. This would allow far greater freedom in positioning the gas tank on site. However, at present, it is not possible to use a forklift truck for this purpose. This is due to the fact that the tank has a tendency to roll away from the forklift truck when the gas tank is lifted on the tines. As will be readily understood, this can be extremely dangerous.

It is known to use various clamp arrangements and other fixing members to secure awkward loads in position on the tines of a forklift however the known clamps and fixing members are unsuitable for use with gas tanks. The presence of vent caps and the like on the gas tank limit the use of an overhead clamp as the clamp would have a tendency to cause damage to those parts of the gas tank. The option of under-slinging the tank on the tines is not available as the gas tank secured in such a manner will have a tendency to damage the mast of the forklift.

It is an object of the present invention to provide a gas tank-handling device that will enable a forklift truck to be used in the placement of a gas tank.

### SUMMARY OF THE INVENTION

According to the invention there is provided a gas tank-handling device for a forklift truck comprising a mounting frame adapted to be attached to a lifting assembly of a forklift truck, a pair of tines carried by the mounting frame and extending forwardly from the mounting frame in the direction of forklift truck travel, each of the tines comprising an L-shaped body having a substantially upright shank terminating in a heel portion at its lower end and a substantially horizontal blade extending forwardly from the heel and terminating in a tip, the blade having a top face, a bottom face and a pair of side faces, the pair of tines further being mounted on the mounting frame for movement towards and away from each other in a lateral direction relative to the direction of forklift truck travel, and in which each of the tines has a stub suitable for engagement of the leg of a gas tank, the stub being mounted on a side face of the tine's blade and protruding outwardly therefrom in a lateral direction relative to the direction of forklift truck travel.

By having such a device, it will be possible to securely engage the gas tank on the tines of a forklift without damaging the gas tank or the forklift mast. This will enable a forklift truck to be used to position the gas tank on site which is highly advantageous. Furthermore, the particular arrangement of gas tank-handling device is simple to construct and relatively inexpensive to manufacture. In addition to the above, the gas tank-handling device will enable an operator to engage, position and disengage the gas tank quickly and with the minimum of difficulty.

In one embodiment of the invention there is provided a gas tank-handling device in which each of the stubs suitable for engagement of the leg of a gas tank is mounted on the outermost side face of the tine's blade.

In one embodiment of the invention there is provided a gas tank-handling device in which each tine has a plurality of stubs spaced apart along the length of the blade, mounted on the side face of the blade and protruding outwardly therefrom in a lateral direction relative to the direction of forklift truck travel.

In one embodiment of the invention there is provided a gas tank-handling device in which there is further provided a sleeve intermediate the stub and the tine, the stub being mounted on the sleeve and the sleeve in turn being mounted on the tine. This is a particularly useful aspect of the present invention and will enable larger tanks to be engaged without having to provide excessive separation between the tines. The sleeves can provide additional reach to engage the tank.

In one embodiment of the invention there is provided a gas tank-handling device in which the sleeve defines a tine-receiving through-bore for mounting the sleeve on the tine. By having a tine-receiving through-bore, the sleeve can be securely fixed in position on the tine. Furthermore, the sleeve may be removed from the tine, if desired, quickly and with little difficulty. This may be advantageous if the tine is to be used to engage other loads in which the sleeve may get in the way.

In one embodiment of the invention there is provided a gas tank-handling device in which the sleeve and the tine each define a bolt-receiving bore for reception of a bolt to secure the sleeve in position relative to the tine.

In one embodiment of the invention there is provided a gas tank-handling device in which the stubs are between 10 mm and 75 mm in length. Preferably, the stubs are of the order of 25 mm in length.

In one embodiment of the invention there is provided a gas tank-handling device in which the mounting frame has a plurality of hooks for engagement of a fork carriage of the lifting assembly of the forklift truck. This is seen as a particularly simple way of attaching the mounting frame to the lifting assembly of the forklift truck and will allow the device to be removed when it is not required.

In one embodiment of the invention there is provided a gas tank-handling device in which the mounting frame further comprises a pair of uprights bridged at their upper end by an upper bracing member and bridged at their lower end by a lower bracing member; the upper bracing member and the lower bracing member each having a transverse guide thereon and in which there is further provided a first extension arm mounted for reciprocal movement in the transverse guide of the upper bracing member and connected adjacent its outermost end to a first one of the tines, a second extension arm mounted for reciprocal movement in the transverse guide of the lower bracing member and connected adjacent its outermost end to the first one of the tines and an actuating ram mounted on the mounting frame for movement of the first one of the tines towards and away from the other tine in a lateral direction relative to the direction of forklift truck travel, and in which the upper bracing member and the lower bracing member each have a second transverse guide thereon and there is further provided a third extension arm mounted for reciprocal movement in the second transverse guide of the upper bracing member and connected adjacent its outermost end to a second one of the tines, a fourth extension arm mounted for reciprocal movement in the second transverse guide of the lower bracing member and connected adjacent its outermost end to the second one of the tines, and an actuating ram mounted on the mounting frame for movement of the second one of the tines towards and away from the other tine in a lateral direction relative to the direction of forklift truck travel.

In one embodiment of the invention there is provided a method of handling a gas tank using a forklift truck, the gas tank comprising a tank body having a pair of ground engaging legs, the forklift truck comprising a gas tank-handling device comprising a mounting frame attached to a lifting assembly of the forklift truck, a pair of tines carried by the mounting frame and extending forwardly from the mounting frame in the direction of forklift truck travel, each of the tines comprising an L-shaped body having a substantially upright shank terminating in a heel portion at its lower end and a substantially horizontal blade extending forwardly from the heel and terminating in a tip, the blade having a top face, a bottom face and a pair of side faces, the pair of tines further being mounted on the mounting frame for movement towards and away from each other in a lateral direction relative to the direction of forklift truck travel, and in which each of the tines has a stub suitable for engagement of the leg of a gas tank, the stub being mounted on a side face of the tine's blade and protruding outwardly therefrom in a lateral direction relative to the direction of forklift truck travel, the method comprising the steps of:
introducing the tines under the tank body adjacent the pair of ground engaging legs;
moving the tines on the mounting frame laterally in opposite directions relative to each other until the stubs engage the ground engaging legs;
raising the tines on the lifting assembly thereby raising the tank and the ground engaging legs off the ground;
moving the tank to a desired location, and, when at the desired location:
lowering the tines on the lifting assembly until the ground engaging legs re-engage the ground;
moving the tines on the mounting frame laterally in the opposite direction until the stubs disengage the ground engaging legs; and
retracting the tines from under the tank body.

This method is seen as a particularly simple and efficient way of handling a gas tank using a forklift truck that will enable the gas tank to be engaged, positioned in a desired location and then disengaged with the minimum of difficulty. The gas tank is secured, via the stubs engaging the ground engaging legs, to the tines and will not have a tendency to roll on the tines. No other connecting straps or chains are required in order to lift the gas tank securely.

In one embodiment of the invention there is provided a method in which the step of moving the tines on the mounting frame laterally in opposite directions relative to each other until the stubs engage the ground engaging legs comprises moving the tines outwardly away from each other.

In one embodiment of the invention the step of moving the tines on the mounting frame laterally in opposite directions relative to each other comprises moving the tines laterally until each tine abuts against one of the ground engaging legs. This will provide an even better engagement of the gas tank with the tines of the forklift truck thereby ensuring safer transport of the gas tank.

In one embodiment of the invention the method comprises the intermediate step of tilting the lifting assembly backwards on the forklift truck subsequent to causing the stubs to engage the ground engaging legs and prior to raising the tines on the lifting assembly.

In one embodiment of the invention the method comprises the intermediate step of tilting the lifting assembly forwards on the forklift truck subsequent to lowering the tines on the lifting assembly and prior to moving the tines laterally in the opposite direction to cause the stubs to disengage the ground engaging legs.

In one embodiment of the invention there is provided a forklift truck comprising a chassis having a plurality of ground engaging wheels, a driver's station mounted on one side of the chassis and a motive power unit mounted on the opposite side of the chassis relative to the driver's station, a lifting assembly mounted at the front of the chassis relative the normal direction of movement of the forklift truck, and a gas tank-handling device mounted on the lifting assembly of the forklift truck, the gas tank-handling device comprising a pair of tines carried by the mounting frame and extending forwardly from the mounting frame in the direction of forklift truck travel, each of the tines comprising an L-shaped body having a substantially upright shank terminating in a heel portion at its lower end and a substantially horizontal blade extending forwardly from the heel and terminating in a tip, the blade having a top face, a bottom face and a pair of side faces, the pair of tines further being mounted on the mounting frame for movement towards and away from each other in a lateral direction relative to the direction of forklift truck travel, and in which each of the tines has a stub suitable for engagement of the leg of a gas tank, the stub being mounted on a side face of the tine's blade and protruding outwardly therefrom in a lateral direction relative to the direction of forklift truck travel.

In one embodiment of the invention there is provided a forklift truck in which each of the stubs suitable for engagement of the leg of a gas tank is mounted on the outermost side face of the tine's blade.

In one embodiment of the invention there is provided a forklift truck in which each tine has a plurality of stubs spaced apart along the length of the blade, mounted on the side face of the blade and protruding outwardly therefrom in a lateral direction relative to the direction of forklift truck travel.

In one embodiment of the invention there is provided a forklift truck in which there is further provided a sleeve intermediate the stub and the tine, the stub being mounted on the sleeve and the sleeve in turn being mounted on the tine.

In one embodiment of the invention there is provided a forklift truck in which the sleeve defines a tine-receiving through-bore for mounting the sleeve on the tine.

### BRIEF DESCRIPTION OF THE DRAWINGS

The invention will now be more clearly understood from the following description of some embodiments thereof given by way of example only with reference to the accompanying drawings, in which:—

FIG. 1 is a front perspective view of a gas tank-handling device according to the invention;

FIG. 2 is a rear perspective view of the gas tank-handling device of FIG. 1 engaging a gas tank;

FIG. 3 is a side view of a tine forming part of the gas tank-handling device of FIG. 1;

FIG. 4 is a top plan view of the tine forming part of the gas tank-handling device of FIG. 1;

FIG. 5 is a front elevation view of the tine forming part of the gas tank-handling device of FIG. 1;

FIG. 6 is a perspective view of the tine forming part of the gas tank-handling device of FIG. 1;

FIG. 7 is a front perspective view of an alternative embodiment of gas tank-handling device according to the invention;

FIG. 8 is a partially exploded view of the gas tank-handling device as shown in FIG. 7;

FIG. 9 is a rear perspective view of the gas tank-handling device of FIG. 7 engaging a gas tank;

FIG. 10 is an enlarged view of the boxed portion marked A in FIG. 9; and

FIG. 11 is a rear perspective view of a forklift truck with the gas tank-handling device according to the invention lifting a gas tank;

FIG. 12 is a front perspective view of the forklift truck of FIG. 11 with the gas tank-handling device according to the invention lifting a gas tank;

FIG. 13 is a front perspective view of a second alternative embodiment of gas tank-handling device according to the invention; and

FIG. 14 is a front perspective view of the gas tank-handling device shown in FIG. 13 engaging a gas tank.

### DESCRIPTION OF THE PREFERRED EMBODIMENTS

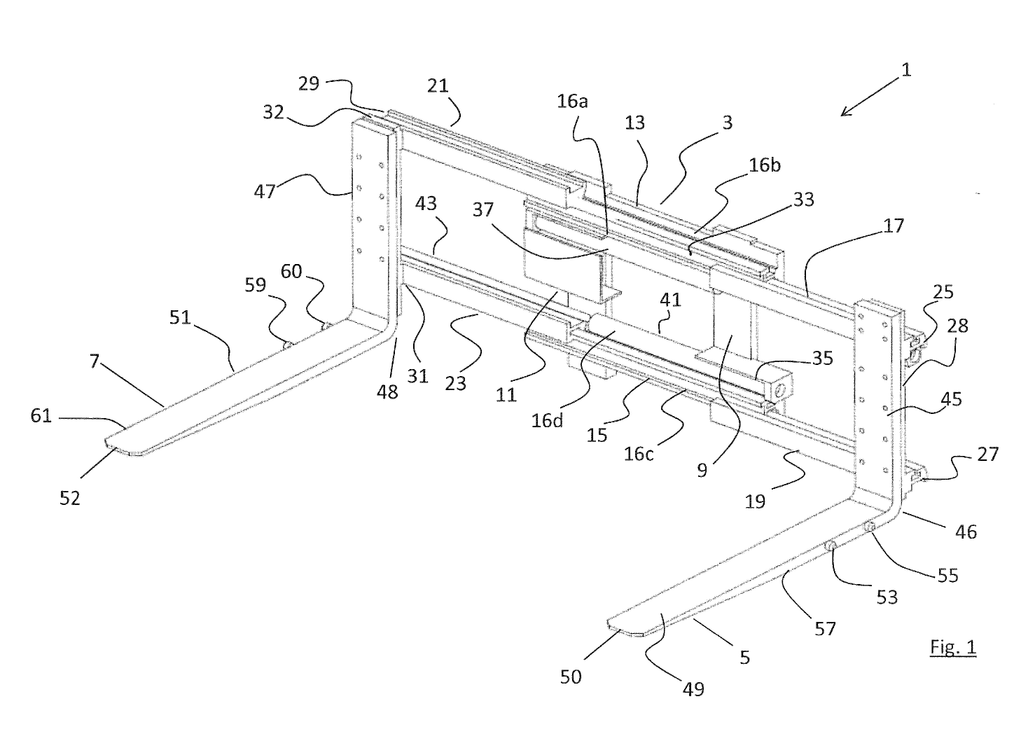

Referring to FIG. 1, there is shown a gas tank-handling device, indicated generally by the reference numeral 1, comprising a mounting frame 3 mounting a pair of tines 5, 7. The mounting frame 3 further comprises a pair of uprights 9, 11 bridged by an upper bracing member 13 and a lower bracing member 15. The upper bracing member 13 and the lower bracing member 15 each have a pair of transverse guides 16a, 16b, 16c, 16d, each for reception of a tine extension arm 17, 19, 21, 23. Extension arms 17 and 19 are connected adjacent their outermost ends 25, 27 to a tine receiving plate 28 upon which the tine 5 is mounted and extension arms 21, 23 are connected adjacent their outermost ends 29, 31 a tine receiving plate 32 upon which the tine 7 is mounted.

The gas tank handling device 1 further comprises a pair of fluid actuated rams, 33, 35 mounted on the mounting frame 3. Fluid actuated ram 33 comprises a cylinder 37 and a piston (not shown). The outermost end of the piston is connected to the tine 5 via the tine receiving plate 28. The fluid actuated ram 35 also comprises a cylinder 41 and a piston 43. The outermost end of the piston 43 is connected to the tine 7 via the tine receiving plate 32. Each of the tines 5, 7 is substantially L-shaped and comprise an upright, substantially vertical shank 45, 47 terminating in a heel portion 46, 48 at its lowermost end and a substantially horizontal blade 49, 51 that extends forwardly from the heel portion 46, 48 and terminates in a tip 50, 52 at its forwardmost end. The blades 49, 51 each comprise a top face, a bottom face and a pair of side faces. There is provided a pair of stubs 53, 55 on the outermost side face 57 of the tine 5 and protruding outwardly therefrom in a lateral direction relative to the direction of forklift truck travel. There is also provided a pair of stubs 59, 60 on the outermost face 61 of the tine 7 and protruding outwardly therefrom in a lateral direction relative to the direction of forklift truck travel.

Extension of the ram 33 will cause the piston to move out of the cylinder 37 which in turn will cause the extension arms 17 and 19 to move in the transverse guides 16a, 16c pushing the tine 5 outwards away from the other tine 7. Retraction of the ram 33 will have the opposite effect, namely the piston will move inward relative the cylinder 37 which will cause the extension arms 17, 19 to move in the transverse guides 16a, 16c pulling the tine 5 inwards towards the other tine 7. Extension of the ram 35 will cause the piston 43 to move out of the cylinder 41 which in turn will cause the extension arms 21 and 23 to move in the transverse slots 16b, 16d pushing the tine 7 outwards away from the other tine 5. Retraction of the ram 35 will have the opposite effect, namely the piston 43 will move inward relative the cylinder 41 which will cause the extension arms 21, 23 to move in the transverse slots 16b, 16d pulling the tine 7 inwards towards the other tine 5. As the tines 5, 7 move towards and away from each other, the substantially horizontal blade portions 49, 51 of the tines 5, 7 remain substantially parallel with respect to each other.

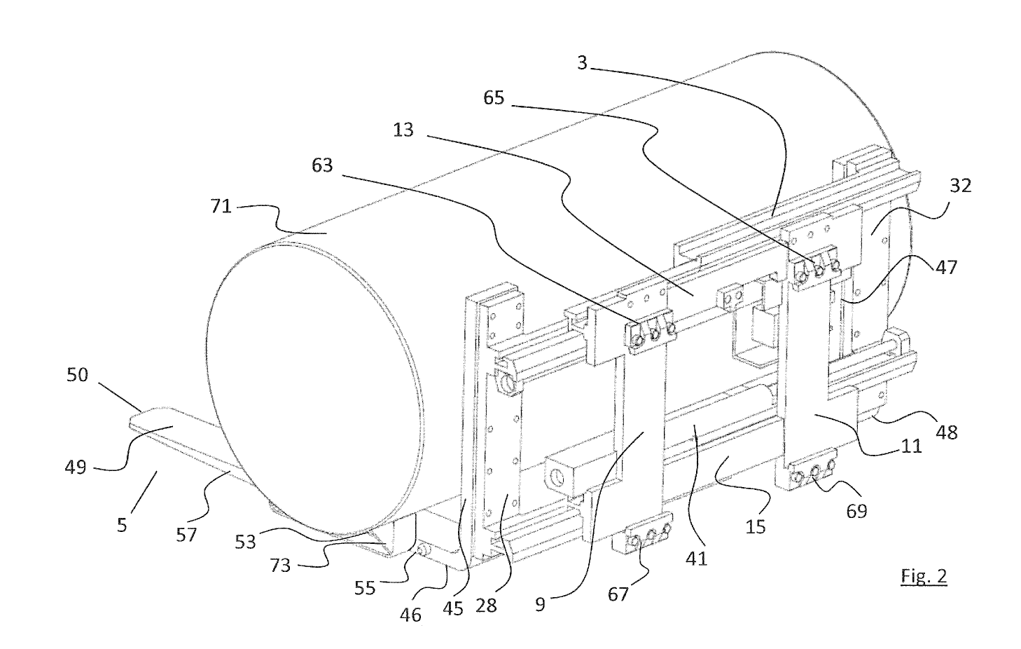

Referring specifically to FIG. 2, the mounting frame comprises a plurality of hooks 63, 65, 67 and 69 for engagement of a fork carriage (not shown) of a lifting assembly of a forklift truck. There is further shown a gas tank 71 having a pair of ground engaging legs, 73, 75, only one of which 73, can be seen in FIG. 2. The other leg 75 is positioned in a similar position to leg 73 but adjacent the opposite end of the gas tank.

In use, an operator of the forklift truck will drive the forklift truck with the tines 5, 7 in close proximity to each other, or in other words, with the rams 33 and 35 in a retracted configuration, towards the gas tank and will position the blades of the tines 5, 7 underneath the tank 71 between the legs 73, 75. The operator will then extend the rams 33, 35 thereby causing the pair of tines 5, 7 to move outwardly away from each other in a lateral direction relative to the direction of forklift truck travel. As the tines 5, 7 move outwardly, the tine 5 will engage the leg 73 and the tine 7 will engage the leg 75. The stub 53 will positively engage the leg 73 and the stub 59 will positively engage the leg 75. The gas tank 71 will therefore be secured in position on the tines 5, 7 and the operator can lift the gas tank on the forks. Once lifted, the operator will drive the forklift to the desired location and place the gas tank in the desired location by lowering the forks once more. Once the forks are lowered, the rams 33, 35 are retracted thereby causing both the stub 53 and the tine 5 to disengage from the leg 73 and both the stub 59 and the tine 7 to disengage from the leg 75. The forklift truck operator can then reverse away from the gas tank and leave the gas tank in the desired location.

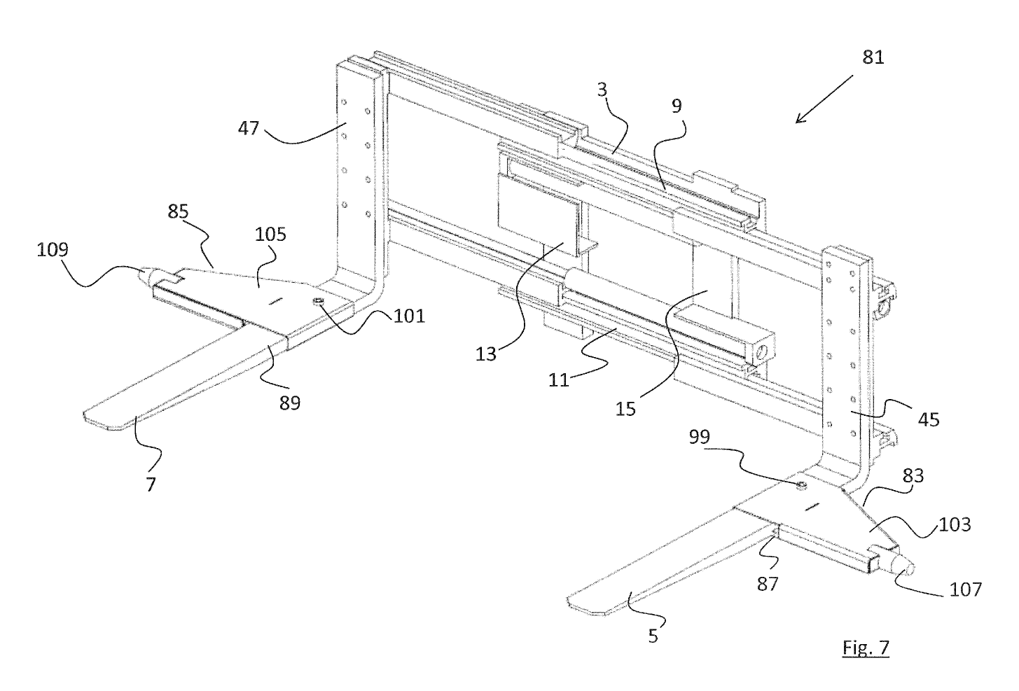

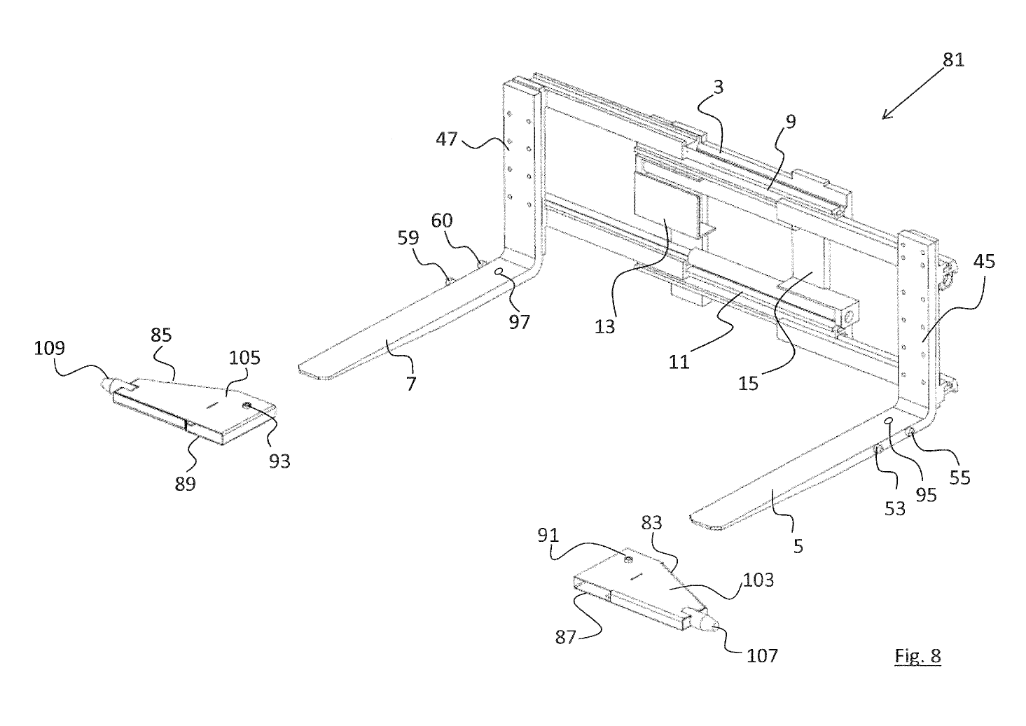

It can be seen that the stub 53 positively engages the leg 73 whereas the stub 55 remains rearwardly of the leg 73. Similarly, the stub 59 positively engages the leg 75 and the stub 60 remains rearwardly of the leg. In this way, the stubs 53, 59 act as spears to engage the legs 73, 75 respectively whereas the stubs 55 and 60 act as backstops or spacers to the legs 73, 75. The stubs 53, 55, 59 and 60 are substantially cylindrical but it is envisaged that other shaped stubs could be provided. For example, the stubs 55, 60 could be cuboid if desired. The stubs 59, 60 also act as positioning and/or securing means for sleeves (not shown) that may be placed on the blades. The sleeves will be described in further detail below with reference to FIGS. 7 and 8.

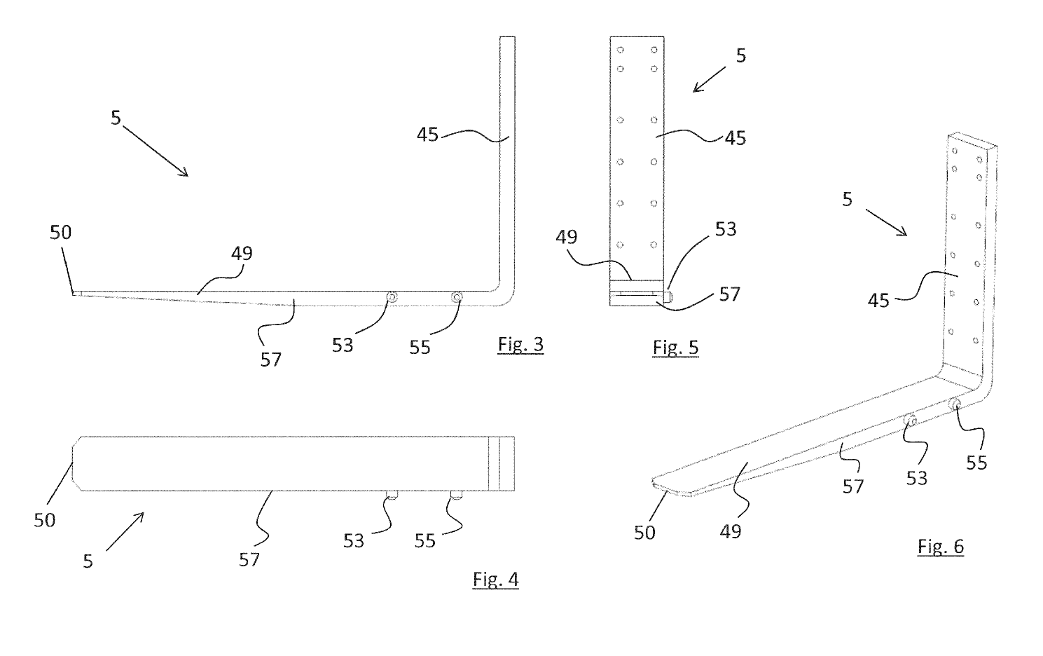

Referring to FIGS. 3 to 6 inclusive, there are shown various views of a tine 5 which forms part of the gas tank-handling device 1 according to the invention. The tine 5 shown in the drawings is bolted on to a tine receiving plate (not shown) which in turn is mounted on the mounting carriage (not shown). The tine 5 has a pair of stubs 53, 55 on the outermost face 57 of the tine 5 and protruding outwardly therefrom. Each of the stubs 53, 55 protrudes 25 mm from the outermost face 57 of the tine 5. The tine 7 is practically identical in construction to the tine 5 with the exception that the stubs on the tine 7 are on the opposite side face of the tine 7 to that shown for tine 5.

Referring to FIGS. 7 and 8, there is shown an alternative embodiment of gas tank-handling device according to the invention, indicated generally by the reference numeral 81, where like parts have been given the same reference numerals as before. The gas tank-handling device 81 comprises a pair of sleeves 83, 85 each having a tine-receiving through bore 87, 89 respectively for reception of a tine. The sleeves each have a bolt-receiving bore 91, 93 and there are provided a complementary pair of bolt-receiving bores 95, 97 in the tines 5, 7 respectively. The tines 5, 7 are inserted into the tine-receiving through bore 87, 89, respectively, of the sleeves 83, 85, respectively, and the sleeves 83, 85 are slid along the tines 5, 7 until the bolt-receiving bores 91, 93 in the sleeves 83, 85 are in alignment with the bolt-receiving bores 95, 97 in the tines 5, 7. Once in alignment, a bolt 99 is inserted into the bolt-receiving bores 91, 95 and a second bolt 101 is inserted into the bolt-receiving bores 93, 97, thereby securing the sleeves 83, 85 in position relative the tines 5, 7.

The sleeves 83, 85 each comprise a plate 103, 105 that extends outwardly from the tine laterally with respect to the direction of travel of the forklift and there is provided a stub 107, 109 extending outwardly from the plate 103, 105. Again, the stubs 107, 109 protrude outwardly from the plates and by extension protrude outwardly from the tines in a lateral direction relative to the direction of forklift truck travel. The plates 103, 105 effectively act as extensions for the stubs 107, 109 so that the gas tank-handling device 81 can be used to engage wider tanks or tanks with legs that are positioned further apart without having to provide longer rams 33, 35 or a larger mounting frame 3.

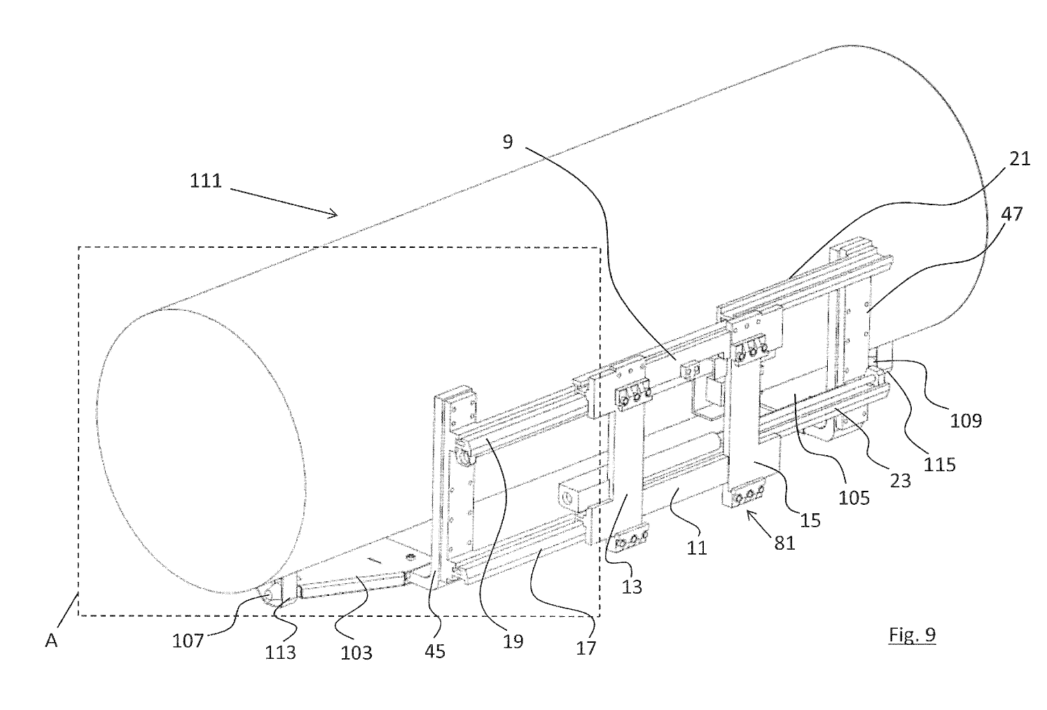

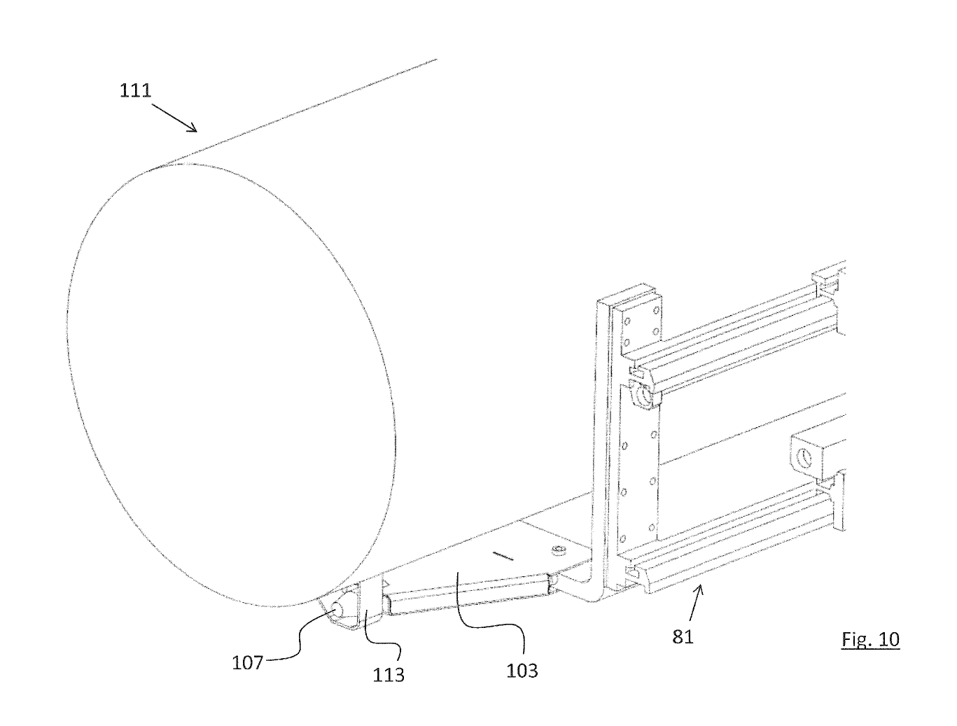

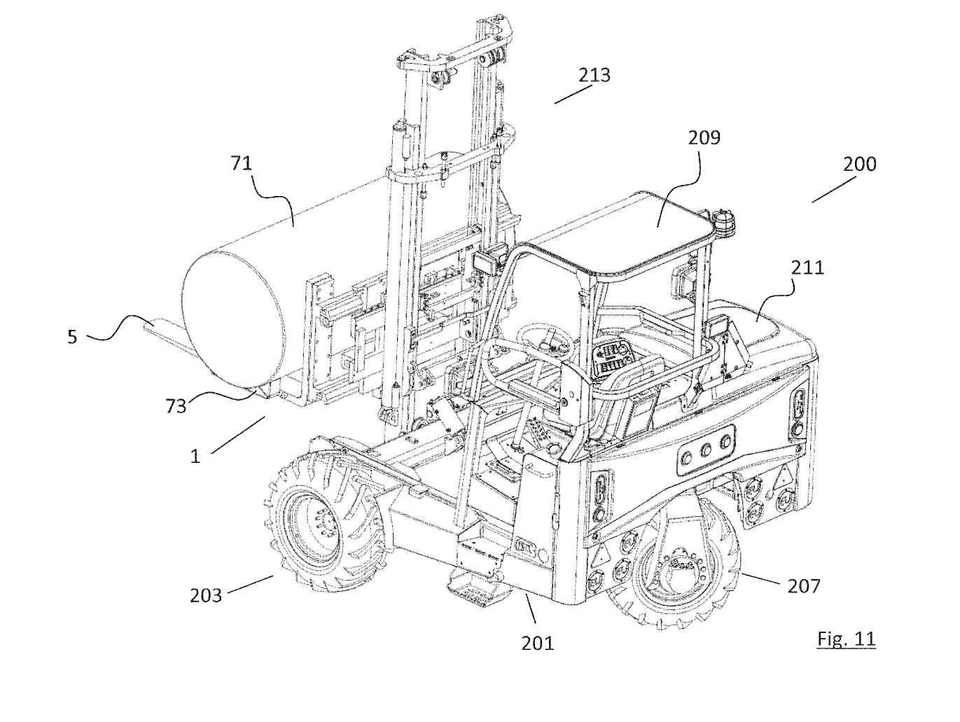

Referring to FIGS. 9 and 10, there is shown a pair of views of the gas tank-handling device 81 engaging an alternative construction of tank, indicated generally by the reference numeral 111. The tank 111 is longer than the previous tank 71 and accordingly the legs 113, 115 of tank 111 are spaced further apart than the legs 73, 75 of the tank 71. The sleeves 83, 85 enable the stubs 107, 109 to engage the legs 113, 115 respectively of the tank 111 in the manner described before. In addition to the stubs, the plates 103, 105 will preferably abut against the legs 113, 115 thereby forming a firm engagement between the gas tank-handling device 81 and the gas tank 111. The stubs 55, 60 act as backstops for the sleeves 83, 85 and aid in the positioning of the sleeves.

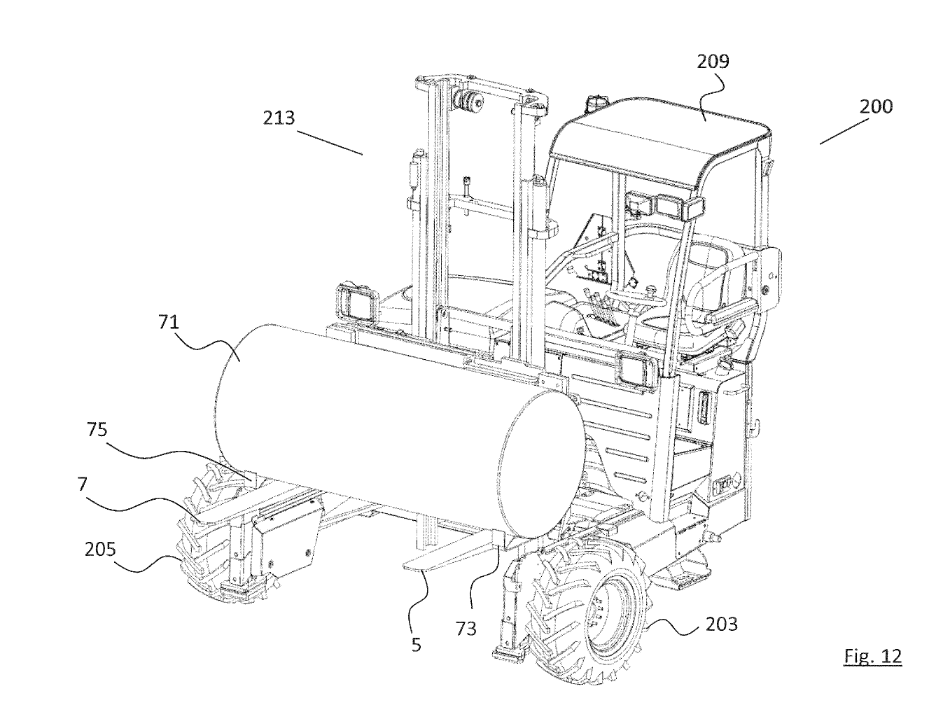

Referring to FIGS. 11 and 12, there is shown a forklift truck indicated generally by the reference numeral 200 having the gas tank-handling device 1 according to the present invention mounted thereon and in use lifting a gas tank 71. The forklift truck 200 comprises a chassis 201 having a plurality of ground engaging wheels including a pair of driven front wheels 203, 205 and a rear steering wheel 207. A driver's station 209 is mounted on one side of the chassis and a motive power unit 211 is mounted on the opposite side of the chassis 201 relative to the driver's station 209. A lifting assembly 213, in this case an upright mast, is mounted at the front of the chassis 201 relative the normal direction of movement of the forklift truck 200 and a gas tank-handling device 1 is mounted on the lifting assembly 213 of the forklift truck.

In FIG. 11, the mast of the piggyback forklift truck is positioned forwardly on the chassis 201 in a position that will allow the piggyback forklift truck to pick up and set down a gas tank. In FIG. 12, the mast has been moved rearward on the chassis to permit safe transit of the piggyback forklift truck and gas tank. The manner in which the mast is moved forwards and rearwards on the chassis will be understood to those skilled in the art of piggyback forklift trucks. The gas tank 71 thus lifted will not have a tendency to roll off the tines 5, 7 due to the positive engagement of the tines 5, 7 with the legs 73, 75 and the stubs 53, 59 with the legs 73, 75. In the embodiment shown, the forklift truck 200 is a piggyback forklift truck with three wheels however four wheels could be provided if desired. Furthermore, a telescopic or other type of mast could be provided instead of the upright mast shown.

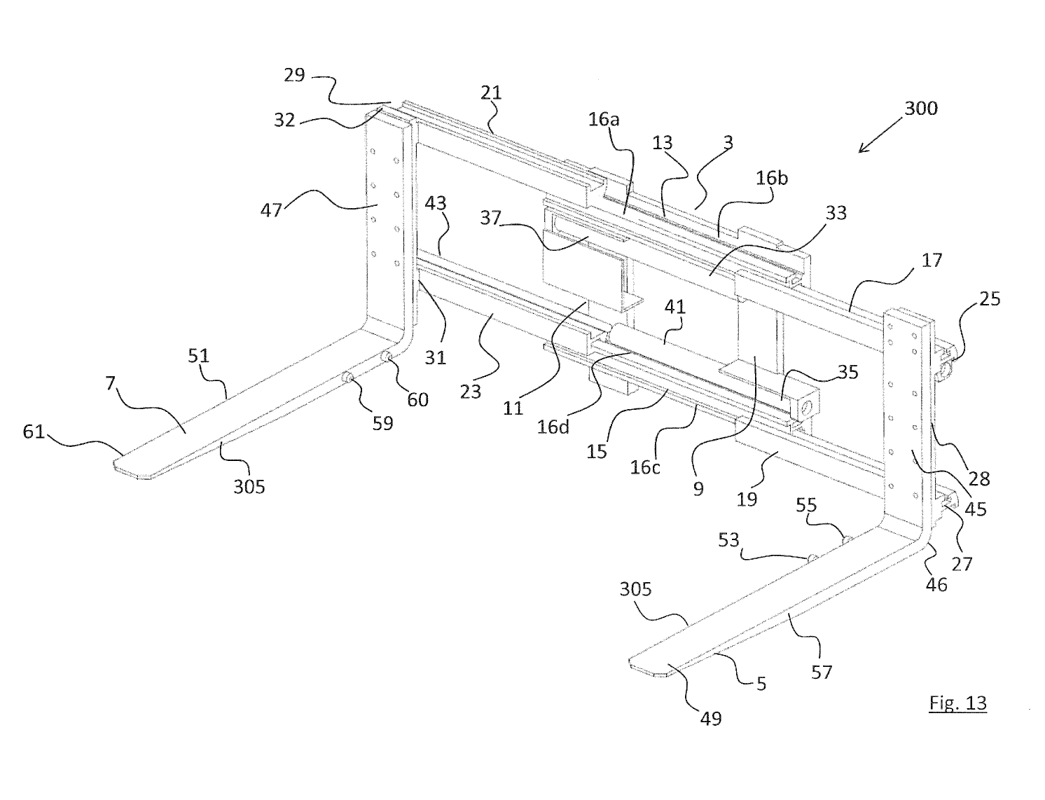

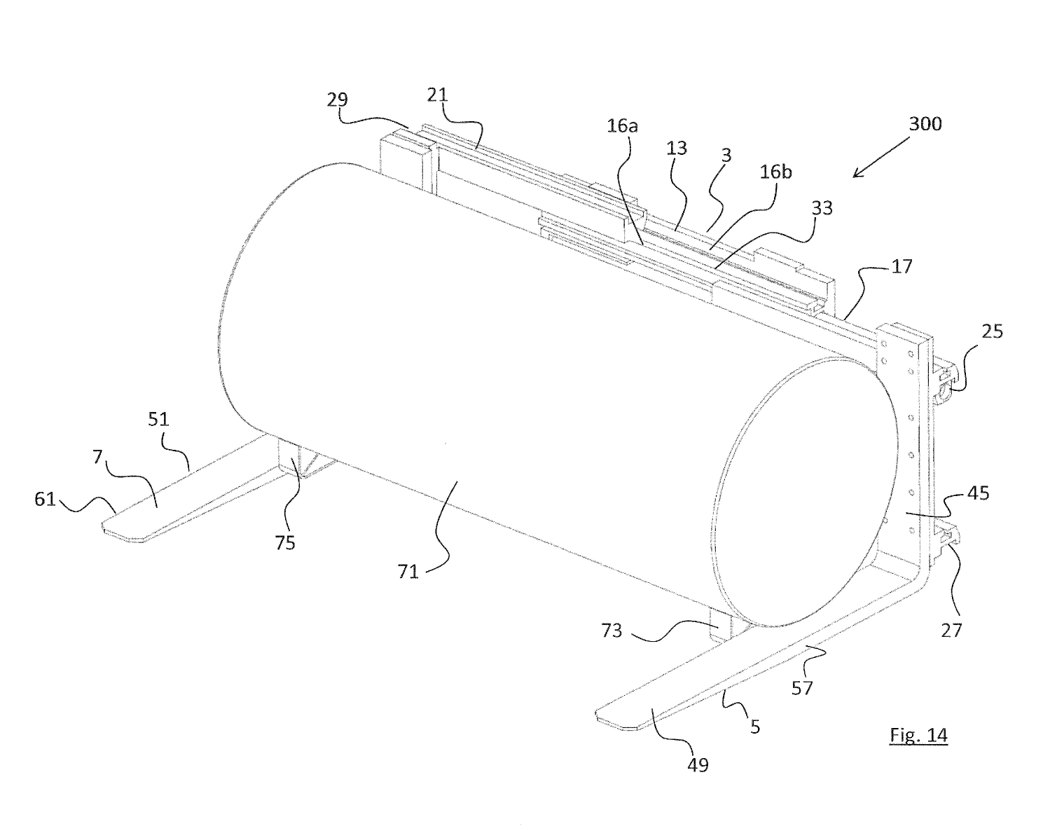

Referring to FIGS. 13 and 14, there is shown a second alternative embodiment of gas tank handling device according to the invention, indicated generally by the reference numeral 300, where like parts have been given the same reference numerals as before. The gas tank handling device 300 differs from the gas tank handling devices previously described in that the stubs 53, 55, 59 and 60 are located on the innermost side faces 303, 305 respectively of their blades.

In use, in order to engage a gas tank 71, the tines 5, 7 are spread apart wider than the distance between the pair of legs 73, 75 of the gas tank 71. The blades of the tines are then placed underneath the gas tank and the tines are drawn towards each other by fluid actuated rams 33, 35 until the stubs 53, 59 engage the legs 73, 75 respectively of the gas tank 71. The tines can be moved further inwards until the blades of the tines make contact with the legs 73, 75 are secure the gas tank to the tines. The gas tank may then be lifted and transported to a desired location. In order to release the gas tank 71 once more, the gas tank is lowered to the ground and the fluid actuated rams 33, 35 are operated once more but in this instance in the opposite direction in order to extend the distance between the tines 5, 7 and release the legs 73, 75 from the stubs 53, 59.

It will be understood that various modifications could be made to the constructions mentioned above without departing from the spirit of the invention or scope of the appended claims. For example, more or less than two stubs could be provided on each tine. Furthermore, the sleeves 83, 85 could be permanently attached to the tines 3, 5 by welding or indeed the sleeves 83, 85 could be formed integrally with the tines 3, 5. The mounting arrangement of the adjustable tines 5, 7 and the extension arms 17, 19, 21, 23 and the manner in which the adjustable tines may be moved by a pair of rams is only one manner in which the tines could be provided to move laterally on the mounting frame and other arrangements could be used to equal effect. For example, the tines could be mounted directly in guides on the mounting frame or could be attached to the mounting frame using one or more than two extension arms. Accordingly, the embodiments shown are illustrative of the preferred manner of providing the invention but are not intended to be limiting as the only manner of performing the present invention.

It is envisaged that if desired, instead of having both tines 5, 7 moveable on the mounting frame, only one of the tines could be moveable on the mounting frame and the other tine could be fixed on the mounting frame. In such a case, it is envisaged that a side shift mechanism on the fork carriage could be used to move the fixed tine laterally until it engages (or disengages if that is what us required) a leg of a gas tank or until the stub thereon engages (or disengages if that is what is required) the leg of a gas tank. The other moveable tine could then be moved into engagement (or disengagement if that is what is required in that operation) by the fluid actuated ram as described above.

As well as having the sleeves adjustable and removable, the tines could be bolted on and removable from the mounting frame or could be permanently fixed or indeed formed integrally with some of the other mounting frame components.

In the embodiment shown, the rams 33, 35 are preferably supplied by double acting rams. Alternatively, single acting rams each with a biasing means such as a very strong spring acting to return their piston from an extended configuration to a retracted configuration could be provided. In the embodiment shown, there are four transverse guides 16a, 16b, 16c and 16d but it is envisaged that in some cases one or two transverse guides may be sufficient depending on the design of mounting frame chosen. For example, a single transverse guide could be provided in the upper bracing member 13 and a single transverse guide could be provided in the lower bracing member 15. What is important to realise is that the number of transverse guides is arbitrary and indeed other tracks, slots or the like could be provided to act as a guide to the extension arms. Finally, the lateral movement of the forks can in some instances damage paintwork. Accordingly, in some instances anti-scratch finishes such as a rubber or plastic material can be added to the forks and/or the sleeves.

In this specification the terms “comprise, comprises, comprised and comprising” and the terms “include, includes, included and including” are all deemed interchangeable and should be afforded the widest possible scope and interpretation.

The invention is in no way limited to the embodiments hereinbefore described but may be varied in both construction and detail within the scope of the claims.

What is claimed is:

1. A gas tank-handling device for a forklift truck comprising a mounting frame adapted to be attached to a lifting assembly of a forklift truck, a pair of tines carried by the mounting frame and extending forwardly from the mounting frame in the direction of forklift truck travel, each of the tines comprising an L-shaped body having a substantially upright shank terminating in a heel portion at its lower end and a substantially horizontal blade extending forwardly from the heel and terminating in a tip, the blade having a top face, a bottom face and a pair of side faces, the pair of tines further being mounted on the mounting frame for movement towards and away from each other in a lateral direction relative to the direction of forklift truck travel, and in which each of the tines has a stub suitable for engagement of the leg of a gas tank, the stub being mounted on a side face of the tine's blade and protruding outwardly therefrom in a lateral direction relative to the direction of forklift truck travel.

2. The gas tank-handling device as claimed in claim 1 in which each of the stubs suitable for engagement of the leg of a gas tank is mounted on the outermost side face of the tine's blade.

3. The gas tank-handling device as claimed in claim 1 in which each tine has a plurality of stubs spaced apart along the length of the blade, mounted on the side face of the blade and protruding outwardly therefrom in a lateral direction relative to the direction of forklift truck travel.

4. The gas tank-handling device as claimed in claim 1 in which there is further provided a sleeve intermediate the stub and the tine, the stub being mounted on the sleeve and the sleeve in turn being mounted on the tine.

5. The gas tank-handling device as claimed in claim 4 in which the sleeve defines a tine-receiving through-bore for mounting the sleeve on the tine.

6. The gas tank-handling device as claimed in claim 5 in which the sleeve and the tine each define a bolt-receiving bore for reception of a bolt to secure the sleeve in position relative to the tine.

7. The gas tank-handling device as claimed in claim 1 in which the stubs are between 10 mm and 75 mm in height.

8. The gas tank-handling device as claimed in claim 1 in which the mounting frame further comprises a pair of uprights bridged at their upper end by an upper bracing member and bridged at their lower end by a lower bracing member;
the upper bracing member and the lower bracing member each having a transverse guide thereon and in which there is further provided a first extension arm mounted for reciprocal movement in the transverse guide of the upper bracing member and connected adjacent its outermost end to a first one of the tines, a second extension arm mounted for reciprocal movement in the transverse guide of the lower bracing member and connected adjacent its outermost end to the first one of the tines and an actuating ram mounted on the mounting frame for movement of the first one of the tines towards and away from the other tine in a lateral direction relative to the direction of forklift truck travel, and in which
the upper bracing member and the lower bracing member each have a second transverse guide thereon and there is further provided a third extension arm mounted for reciprocal movement in the second transverse guide of the upper bracing member and connected adjacent its outermost end to a second one of the tines, a fourth extension arm mounted for reciprocal movement in the second transverse guide of the lower bracing member and connected adjacent its outermost end to the second one of the tines, and an actuating ram mounted on the mounting frame for movement of the second one of the tines towards and away from the other tine in a lateral direction relative to the direction of forklift truck travel.

9. A method of handling a gas tank using a forklift truck, the gas tank comprising a tank body having a pair of ground engaging legs, the forklift truck comprising a gas tank-handling device comprising a mounting frame attached to a lifting assembly of the forklift truck, a pair of tines carried by the mounting frame and extending forwardly from the mounting frame in the direction of forklift truck travel, each of the tines comprising an L-shaped body having a substantially upright shank terminating in a heel portion at its lower end and a substantially horizontal blade extending forwardly from the heel and terminating in a tip, the blade having a top face, a bottom face and a pair of side faces, the pair of tines further being mounted on the mounting frame for movement towards and away from each other in a lateral direction relative to the direction of forklift truck travel, and in which each of the tines has a stub suitable for engagement of the leg of a gas tank, the stub being mounted on a side face of the tine's blade and protruding outwardly therefrom in a lateral direction relative to the direction of forklift truck travel, the method comprising the steps of:
introducing the tines under the tank body adjacent the pair of ground engaging legs;
moving the tines on the mounting frame laterally in opposite directions relative to each other until the stubs engage the ground engaging legs;
raising the tines on the lifting assembly thereby raising the tank and the ground engaging legs off the ground;
moving the tank to a desired location, and, when at the desired location:
lowering the tines on the lifting assembly until the ground engaging legs re-engage the ground;
moving the tines on the mounting frame laterally in the opposite direction until the stubs disengage the ground engaging legs; and
retracting the tines from under the tank body.

10. The method as claimed in claim 9 in which the step of moving the tines on the mounting frame laterally in opposite directions relative to each other until the stubs engage the ground engaging legs comprises moving the tines outwardly away from each other.

11. The method as claimed in claim 9 in which the step of moving the tines on the mounting frame laterally in opposite directions relative to each other comprises moving the tines laterally until each tine abuts against one of the ground engaging legs.

12. The method as claimed in claim 9 in which the method comprises the intermediate step of tilting the lifting assembly backwards on the forklift truck subsequent to causing the stubs to engage the ground engaging legs and prior to raising the tines on the lifting assembly.

13. The method as claimed in claim 12 in which the method comprises the intermediate step of tilting the lifting assembly forwards on the forklift truck subsequent to lowering the tines on the lifting assembly and prior to moving the tines laterally in the opposite direction to cause the stubs to disengage the ground engaging legs.

14. A forklift truck comprising a chassis having a plurality of ground engaging wheels, a driver's station mounted on one side of the chassis and a motive power unit mounted on the opposite side of the chassis relative to the driver's station, a lifting assembly mounted at the front of the chassis relative the normal direction of movement of the forklift truck, and a gas tank-handling device mounted on the lifting assembly of the forklift truck, the gas tank-handling device comprising a pair of tines carried by the mounting frame and extending forwardly from the mounting frame in the direction of forklift truck travel, each of the tines comprising an L-shaped body having a substantially upright shank terminating in a heel portion at its lower end and a substantially horizontal blade extending forwardly from the heel and terminating in a tip, the blade having a top face, a bottom face and a pair of side faces, the pair of tines further being mounted on the mounting frame for movement towards and away from each other in a lateral direction relative to the direction of forklift truck travel, and in which each of the tines has a stub suitable for engagement of the leg of a gas tank, the stub being mounted on a side face of the tine's blade and protruding outwardly therefrom in a lateral direction relative to the direction of forklift truck travel.

15. The forklift truck as claimed in claim 14 in which each of the stubs suitable for engagement of the leg of a gas tank is mounted on the outermost side face of the tine's blade.

16. The forklift truck as claimed in claim 14 in which each tine has a plurality of stubs spaced apart along the length of the blade, mounted on the side face of the blade and protruding outwardly therefrom in a lateral direction relative to the direction of forklift truck travel.

17. The forklift truck as claimed in claim 14 in which there is further provided a sleeve intermediate the stub and the tine, the stub being mounted on the sleeve and the sleeve in turn being mounted on the tine.

18. The forklift truck as claimed in claim 17 in which the sleeve defines a tine-receiving through-bore for mounting the sleeve on the tine.
